(19) United States
(12) Patent Application Publication
(10) Pub. No.: US 2024/0337783 A1
(43) Pub. Date: Oct. 10, 2024

(54) SURFACE-MOUNTED WINDOW DECORATION LIGHTING SYSTEM

(71) Applicant: CANADIAN TIRE CORPORATION, LIMITED, Toronto (CA)

(72) Inventors: Samuel CHENG, Toronto (CA); Wendy PHAM, Toronto (CA); Tomasz PIOTROWSKI, Toronto (CA); Jeremy Charies Anthony MAINELLA, Toronto (CA)

(21) Appl. No.: 18/626,906

(22) Filed: Apr. 4, 2024

Related U.S. Application Data
(60) Provisional application No. 63/457,201, filed on Apr. 5, 2023.

(51) Int. Cl. F21V 8/00

(52) U.S. Cl. CPC G02B 6/0025; G02B 6/003; G02B 6/0073; G02B 6/0086

(57) ABSTRACT

There is provided a lighting system for illuminating an optically translucent panel, the panel having an exposed surface, a first edge, and a second edge opposite the first edge. The lighting system comprises a light source having a light-emitting surface, and an optical device configured to be positioned on the exposed surface of the panel adjacent to the first edge, the light-emitting surface of the light source configured to be positioned on the optical device at a non-zero angle relative to the exposed surface of the panel, the optical device configured to direct light emitted by the light-emitting surface into the panel, the light guided within the panel towards the second edge by total internal reflection.

### CROSS-REFERENCE TO RELATED APPLICATIONS

The present application claims priority on U.S. Patent Application No. 63/457,201 filed Apr. 5, 2023, the entire contents of which are incorporated herein by reference.

### TECHNICAL FIELD

This disclosure generally relates to the field of lighting systems, and more particularly to surface-mounted lighting systems for decorating windows.

### BACKGROUND OF THE ART

Lighting systems may be used in a variety of residential, commercial, and industrial applications. For example, around the festive season, it is a common practice to decorate parts of a household with brightly colored luminaries. In this setting, lighting systems may be used to illuminate graphics or decorations provided on or around windows of a household. Existing solutions for window illumination are however deficient in some regards. For instance, existing solutions typically require access to edges of a window panel in order to provide illumination thereto. In addition, some existing solutions prevent the use of existing window panels, thus restricting the potential applications of these solutions.

As such, there is room for improvement.

### SUMMARY

In accordance with one aspect, there is provided lighting system for illuminating an optically translucent panel, the panel having an exposed surface, a first edge, and a second edge opposite the first edge. The lighting system comprises a light source having a light-emitting surface, and an optical device configured to be positioned on the exposed surface of the panel adjacent to the first edge, the light-emitting surface of the light source configured to be positioned on the optical device at a non-zero angle relative to the exposed surface of the panel, the optical device configured to direct light emitted by the light-emitting surface into the panel, the light guided within the panel towards the second edge by total internal reflection.

In some embodiments, the light source comprises one or more light-emitting diodes (LEDs) arranged in an array on a printed circuit board.

In some embodiments, the light source comprises a single light element.

In some embodiments, the optical device is configured to be detachably secured to the exposed surface of the panel using a binding material that is at least partially optically clear, the binding material configured to optically couple the optical device to the panel.

In some embodiments, the binding material is an adhesive.

In some embodiments, the binding material is made of silicon.

In some embodiments, the binding material is a gel.

In some embodiments, the binding material forms the optical device.

In some embodiments, the optical device is a lens configured to refract the light emitted by the light-emitting surface into the panel.

In some embodiments, the lens has a triangular cross-section.

In some embodiments, the lens is a parabolic lens comprising a parabolic surface.

In some embodiments, the parabolic surface of the parabolic lens is coated with a mirror coating.

In some embodiments, the optical device comprises a convex reflective surface, and

the light emitted by the light-emitting surface is incident on the reflective surface, the reflective surface configured to internally reflect the incident light towards the panel.

In some embodiments, the optical device has a planar side surface and a curved upper surface, each having an inner face and an outer face opposite the inner face, the inner face of the upper surface forming the reflective surface.

In some embodiments, the light source is secured to the outer face of the side surface.

In some embodiments, the light source is secured to the inner face of the side surface.

In some embodiments, the light source is received in an opening formed in the side surface.

In some embodiments, the optical device further comprises a first flange surface and a second flange surface, the first flange surface connected to the side surface and extending away therefrom, the second flange surface connected to the upper surface and extending away therefrom.

In some embodiments, the first flange surface and the second flange surface are configured to be coupled to the exposed surface of the panel using a coupling medium.

In some embodiments, the optical device further comprises a planar bottom surface having one end connected to the side surface, the bottom surface configured to be coupled to the exposed surface of the panel.

In some embodiments, the bottom surface has an opening formed therein, the light emitted by the light-emitting surface directed into the panel via the opening.

In some embodiments, the lighting system further comprises a power source integral to the lighting system, the power source electrically connected to the light source for supplying power thereto.

In some embodiments, the optical device is configured to direct the light emitted by the light source into the panel for illuminating at least one indicium provided on the exposed surface of the panel.

In accordance with another aspect, there is provided a method for illuminating an optically translucent panel. The method comprises providing the panel having an exposed surface, a first edge, and a second edge opposite the first edge, providing a light source having a light-emitting surface, and an optical device, positioning the optical device on the exposed surface of the panel adjacent to the first edge, positioning the light-emitting surface of the light source on the optical device, with the light-emitting surface at a non-zero angle relative to the exposed surface of the panel, and causing the light-emitting surface of the light source to emit light and the optical device to direct the light emitted by the light-emitting surface into the panel, the light guided within the panel towards the second edge by total internal reflection.

In accordance with another aspect, there is provided a kit for use in illuminating an optically translucent panel, the panel having an exposed surface, a first edge, and a second edge opposite the first edge. The kit comprises at least one light channel configured to be secured to the exposed surface of the panel adjacent to the first edge of the panel, the at least one light channel comprising a light source having a light-emitting surface and an optical device, the light-emitting surface configured to be positioned on the optical device at a non-zero angle relative to the exposed surface of the panel and the optical device configured to direct light emitted by the light-emitting surface into the panel, the light guided within the panel towards the second edge by total internal reflection, and at least one means for providing on the exposed surface of the panel at least one indicium configured to be illuminated by the light guided within the panel.

In some embodiments, the at least one means for providing the at least one indicium comprises at least one marker for drawing the at least one indicium on the exposed surface of the panel.

In some embodiments, the at least one means for providing the at least one indicium comprises at least one luminescent sticker configured to be affixed to the exposed surface of the panel.

In some embodiments, the kit further comprises at least one erasing means for removing the at least one indicium from the exposed surface of the panel.

In some embodiments, the kit further comprises at least one cable connection for interconnecting multiple ones of the at least one light channel.

In some embodiments, the kit further comprises a power cord for connecting the at least one light channel to an external power source for supplying power to the light source.

In some embodiments, the kit further comprises a power source configured to be electrically connected to the light source for supplying power thereto.

In some embodiments, the kit further comprises a binding material for detachably securing the at least one light channel to the surface of the panel, the binding material being at least partially optically clear and configured to optically couple the at least one light channel to the panel.

In some embodiments, the binding material forms the optical device.

In some embodiments, the binding material is an adhesive, a gel, or is made of silicon.

In some embodiments, the kit further comprises a cover member for concealing the light source and the optical device.

Many further features and combinations thereof concerning the present improvements will appear to those skilled in the art following a reading of the instant disclosure.

### DESCRIPTION OF THE DRAWINGS

In the figures,

FIG. 1 is a schematic diagram of a surface-mounted lighting system, in accordance with one embodiment;

FIG. 2 is a cross-sectional view of the lighting system of FIG. 1 taken along line 2-2, in accordance with one embodiment;

FIG. 3 is a schematic diagram of the light source of FIG. 2, in accordance with one embodiment;

FIGS. 4A, 4B, 4C, 4D, and 4E are cross-sectional views of the lens of FIG. 2, in accordance with various embodiments;

FIGS. 5A, 5B, 5C, 5D, 5E, 5F, 5G, 5H, 5I, and 5J are schematic diagrams of a lighting system in accordance with other embodiments;

FIGS. 6A and 6B are side views of a surface-mounted lighting system, in accordance with other embodiments;

FIG. 7 is a side-view of a lighting system provided with an edge reflector, in accordance with an embodiment;

FIGS. 8A and 8B are schematic diagrams of interconnected lighting systems, in accordance with an embodiment; and

FIG. 9 is a flowchart of a method for illuminating a panel, in accordance with one embodiment.

It will be noted that throughout the appended drawings, like features are identified by like reference numerals.

### DETAILED DESCRIPTION

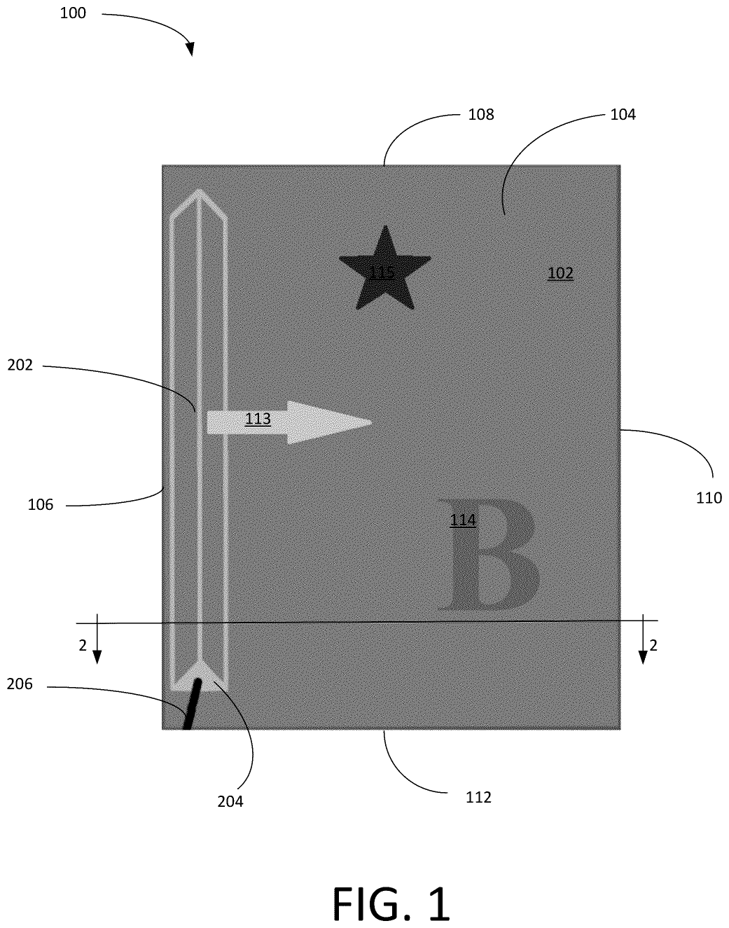

FIG. 1 shows a schematic diagram of an embodiment of a lighting system (also referred to as a light channel) 100 for illuminating a panel 102. The panel 102 is a planar structure made of an optically translucent material including, but not limited to, glass, plastic or acrylic. In one embodiment, the panel 102 is a standard double pane residential glass window and the lighting system 100 is used to illuminate indicia provided on the window, as will be described further below. It should however be understood that, in addition to residential applications, the lighting system 100 may be used for commercial or industrial (e.g., signage) applications. Therefore, other embodiments of the panel 102 may apply.

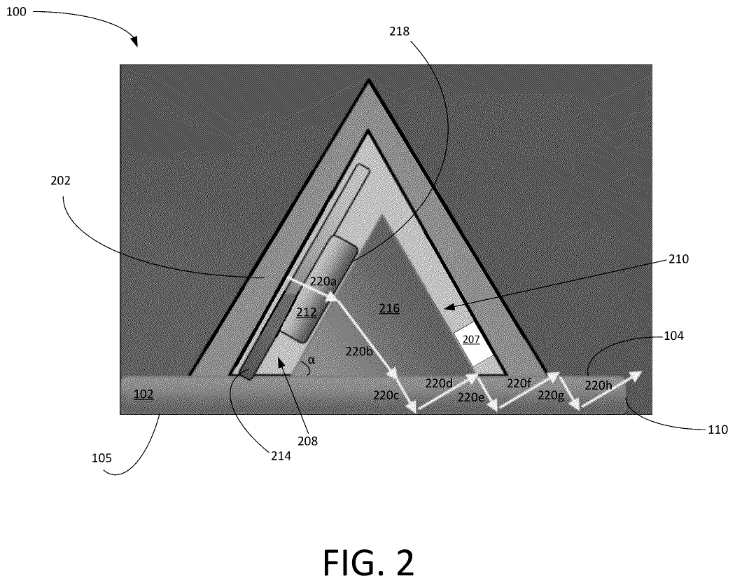

The panel 102 has a first (e.g., upper) surface 104 and a second (e.g., lower) surface (reference 105 in FIG. 2) opposite to the first surface 104. The panel 102 is bounded by side edges 106, 108, 110, 112, with edges 106 and 110 and edges 108 and 112 being opposite to one another, respectively. The lighting system 100 is provided on a surface of the panel 102, for instance on surface 104, and positioned along an edge of the panel 102, for instance along the edge 106. Although FIG. 1 illustrates the lighting system 100 as being provided on surface 104 of the panel 102, it should be understood that the lighting system 100 may alternatively be provided on the opposite surface 105. In addition, although FIG. 1 illustrates the lighting system 100 as being positioned along the edge 106 of the panel 102, it should be understood that the lighting system 100 may alternatively be provided along any one of edges 108, 110, or 112. As will be discussed further below, the lighting system 100 may also be configured to span more than one edge 106, 108, 110, 112 in order to increase the overall light intensity provided to the panel 102.

In operation, the lighting system 100 provides illumination away from the edge(s) of the panel 102 adjacent to which the lighting system 100 is positioned, and towards the opposite edge(s) of the panel 102. In the embodiment of FIG. 1, illumination is provided along a direction 113, away from the edge 106 and towards the opposite edge 110. One or both of the surfaces 104, 105 of the panel 102 may be exposed at any given time such that the illumination provided by the lighting system 100 may be visible on one or both of the surfaces 104 and 105. In one embodiment, the lighting system 100 illuminates the entire exposed surface(s) 104 and/or 105 of the panel 102. It should however be understood that, in other embodiments, the lighting system 100 may illuminate part of the exposed surface(s) 104 and/or 105.

Indicia 114 and 115 are provided on at least one surface of the panel 102 and are configured to be illuminated by the lighting system 100. In the embodiment illustrated in FIG. 1, the indicia 114, 115 are provided on the surface 104. It should however be understood that indicia may alternatively or additionally be provided on the opposite surface 105. It should also be understood that any suitable type and/or number of indicia as in 114, 115 may be provided. In one embodiment, the indicia 114, 115 comprises at least one luminescent sticker affixed to the panel 102. In another embodiment, the indicia 114, 115 is drawn by a user on the surface 104 of the panel 102 using any suitable means including, but not limited to, a white marker, a liquid chalk marker, an erasable marker, a wet wipe marker, a neon marker, a glass writer, and the like. Other embodiments may apply.

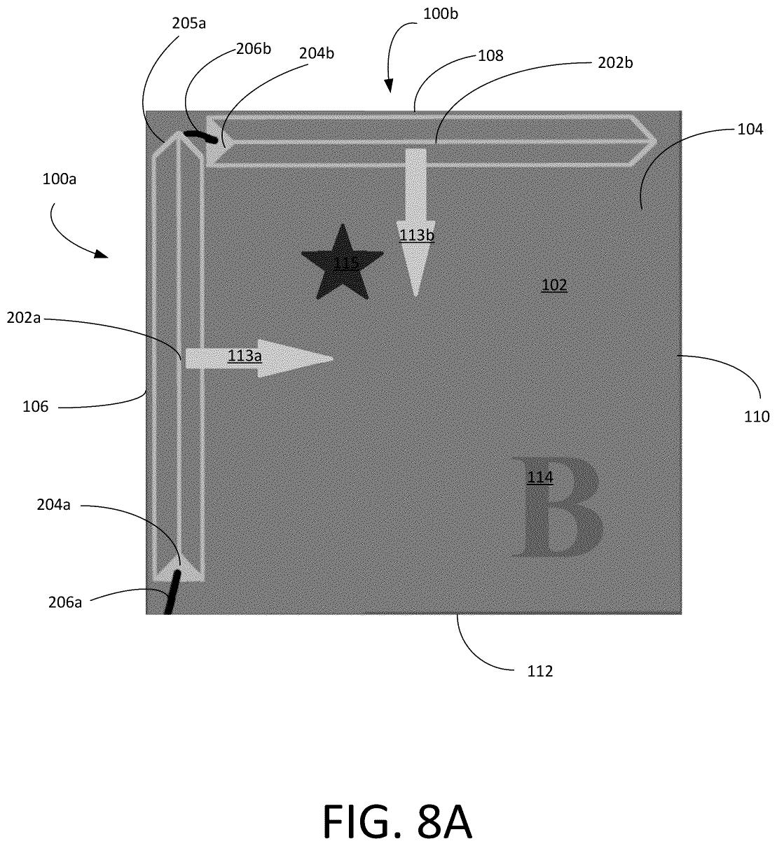

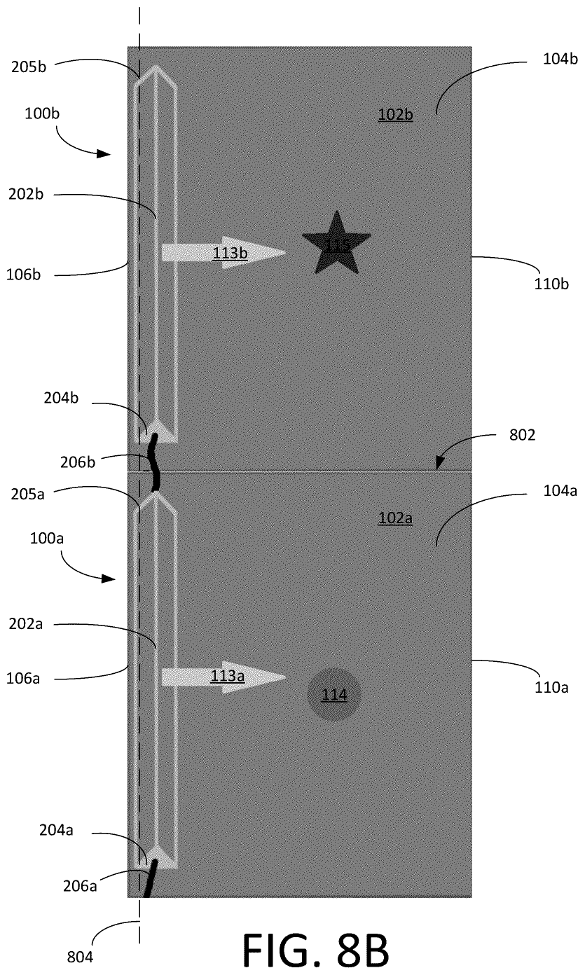

Referring now to FIG. 2 in addition to FIG. 1, in one embodiment, the lighting system 100 illustratively comprises an elongated cover member 202 enclosing internal components (not shown) of the lighting system 100 for concealment and protection thereof. An end cap 204 is provided at one end (not shown) of the cover member 202 for protecting the internal components of the lighting system 100. Although not illustrated, it should be understood that another end cap may also be provided at the other end of the cover member 202. In some embodiments, power from an external power source (e.g., the electrical power grid) may be supplied to the internal components of the lighting system 100 (e.g., to light source 208) via a power cord 206 secured to the end of the cover member 202. In some embodiments, the power cord 206 may also serve as an extension cord for connecting to an additional lighting system (not shown), as will be described further below with reference to FIGS. 8A and 8B.

In some embodiments, power from a dedicated power source (reference 207 in FIG. 2) may be supplied to the internal components of the lighting system 100 (e.g., to the light source 208) via an internal distribution system (e.g., electrical wires, conductors, or the like, not shown) that electrically connects the internal components of the lighting system 100 to the dedicated power source 207. As used herein, the term “dedicated power source” therefore refers to a power source (other than the electrical grid) configured for only supplying power to the lighting system 100 (e.g., to the light source 208). The dedicated power source 207 is a component of the lighting system 100 (i.e. it is integral therewith) and may be provided at any suitable position relative to the internal components of the lighting system 100. In the illustrated embodiment, the dedicated power source 207 is provided within the lighting system (e.g., encapsulated by the cover member 202). In other embodiments, the dedicated power source 207 may be positioned on the cover member 202. Other embodiments may apply.

The dedicated power source 207 may comprise, for example, one or more batteries (not shown) provided with the lighting system 100. The one or more batteries may comprise, for example, nickel cadmium batteries (also known as Ni—Cd or NiCad batteries), lithium-ion batteries (also known as Li-ion batteries), silver oxide batteries, alkaline batteries, zinc-carbon batteries, or the like. The one or more batteries may be provided within the lighting system 100 (i.e. inside the elongated cover member 202 enclosing the internal components of the lighting system 100), for example within a dedicated battery compartment (not shown) illustratively connected to the internal distribution system. The one or more batteries may be removable from the lighting system 100, e.g. by a user for purposes of inspection, replacement, and the like. The one or more batteries may be rechargeable, for instance in a battery charging station (not shown) external to the lighting system 100. In some embodiments, the batteries may be rechargeable directly within the lighting system 100, for example within the dedicated battery compartment, during operation of the lighting system 100.

Still other embodiments may apply, for instance wherein the dedicated power source 207 may additionally or alternatively comprise a renewable energy source, for instance a solar array (i.e. a group of photovoltaic solar panels or cells) (not shown) provided with the lighting system 100 for supplying power to the lighting system 100. The solar array may be used to recharge the one or more batteries, and may operate redundantly or independently of the one or more batteries, and of an external power source (e.g. the electrical power grid) for supplying power to the lighting system 100. In some embodiments, the solar array may be positioned on the elongated cover member 202 of lighting system 100 for advantageous exposure to sunlight. Other possibilities may also apply, for instance where the solar array may be provided externally to the lighting system 100, for instance on a surface of the panel 102, and connected by some appropriate means for supplying power to the lighting system 100 and/or to recharge the one or more batteries, for instance by a power cord. Still other possibilities may apply, as will be recognized by the person skilled in the art having the benefit of the present disclosure.

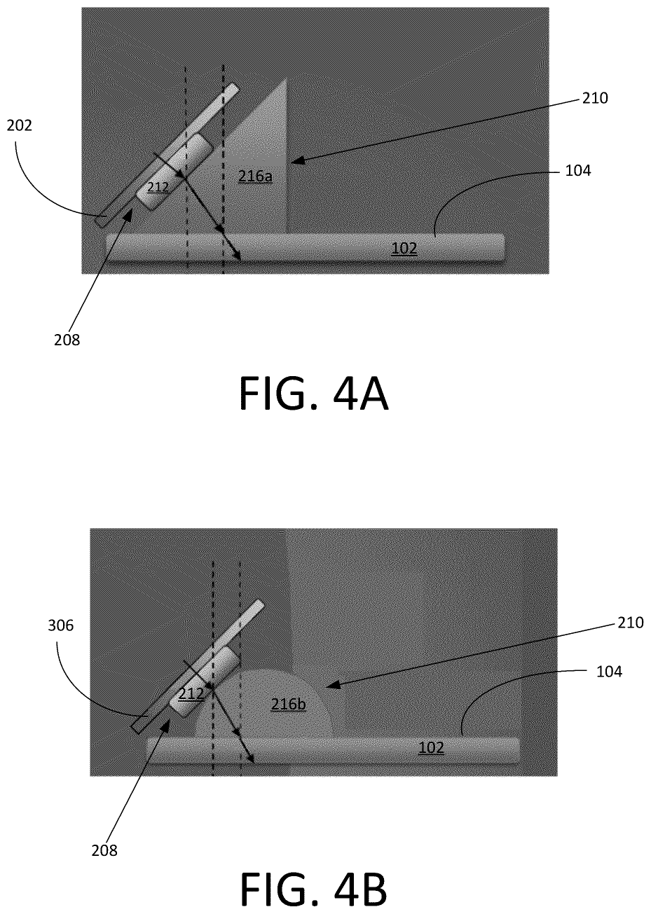

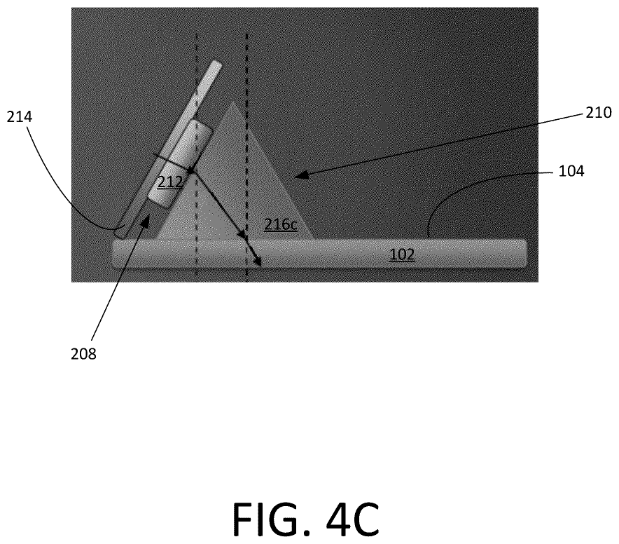

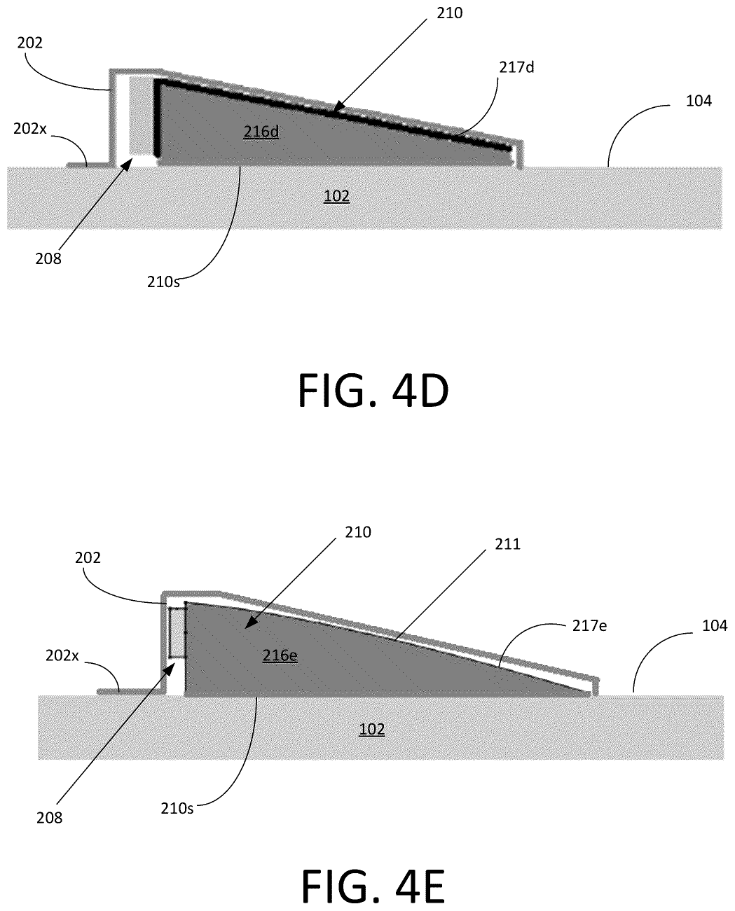

The lighting system 100 further comprises the light source 208 and a coupling medium 210, which are enclosed in the cover member 202 as shown in FIG. 2. In one embodiment, the light source 208 comprises a plurality of light-emitting diodes (LEDs) 212 provided on a printed circuit board (PCB) 214. The LEDs 212 are front-emitting diodes. The PCB 214 may be a flexible circuit board. Although reference is made herein to the light source 208 comprising multiple light elements (e.g., LEDs as in 212), it should be understood that, in some embodiments, the light source 208 may comprise a single light element (e.g., a single LED, a light strip or the like). In the illustrated embodiment, the coupling medium 210 comprises a lens 216 and an at least partially optically clear adhesive (not shown) that detachably secures the lens 216 to a surface (e.g., surface 104) of the panel 102. The at least partially optically clear adhesive may be tinted, and may illustratively comprise adhesive tape. It should be understood that the adhesive may secure remaining components of the lighting system 100, such as the cover member 202, to the panel 102. Any suitable adhesive including, but not limited to, double-sided adhesive tape, mounting tape, silicone adhesive, mineral oil, and the like, may apply. When adhesive tape is used, the tape may be transparent, invisible, matte, or the like. It should however be understood that the coupling medium 210 may comprise any suitable binding material other than an adhesive. For example, gel, silicon, or any other suitable semi-translucent material, may apply. As will be described below with reference to FIGS. 4A, 4B, and 4C, the lens 216 may have any suitable cross-sectional shape. A light-emitting surface 218 of the light source 208 is positioned adjacent the lens 216 such that the light emitted by the LEDs 212 is directed by the lens 216 into the panel 102.

The light emitted by the light source 208 is refracted by the lens 216 and the resulting refracted light is directed into the panel 102 and propagating therein using the principle of total internal reflection (TIR), as illustrated by arrows 220a, 220b, 220c, 220d, 220e, 220f, 220g, and 220h in FIG. 2. Achieving TIR allows for the most efficient light distribution within a medium. The coupling angle (α) between the light-emitting surface 218 of the light source 208 and the surface 104 of the panel 102 determines the direction of the incident light emitted by the light source 208 and entering (i.e. transmitted into) the panel 102. In some embodiments, the coupling angle is set such that the light-emitting surface 218 is at a non-zero angle to the surface 104. In the embodiment of FIG. 2, the light source 208 emits incident light along a first direction (illustrated by arrow 220a). The incident light is refracted according to Snell's law and propagates within the lens 216 where it is further refracted. In particular, the incident light is refracted at the interface between the light source 208 and the lens 216, along a second direction (illustrated by arrow 220b). The refracted light is then further refracted (as illustrated by arrow 220c) at the interface between the lens 216 and the panel 102 and propagates within the panel 102 by TIR (as illustrated by arrows 220d, 220e, 220f, 220g, and 220h). As known to those skilled in the art, TIR occurs when light is travelling in a denser medium and approaches a less dense medium. In the present case, the lens 216 has an index of refraction larger than that of the medium (e.g., air, not shown) surrounding the lens 216, and the panel 102 has an index of refraction larger than that of the lens 216. This allows for TIR to occur within the interface between the panel 102 and the surrounding medium. Indeed, the light refracted at the interface between the lens 216 and the panel 102 is totally reflected within the panel 102, resulting in the propagation of light through the panel 102 towards the opposite edge (e.g., edge 110) of the panel 102, as indicated by arrows 220c, 220d, 220e, 220f, 220g, and 220h. Escaped light may then exit the panel 102 at the edge 110 and disperse in the surrounding medium, ending the propagation of light through the panel 102.

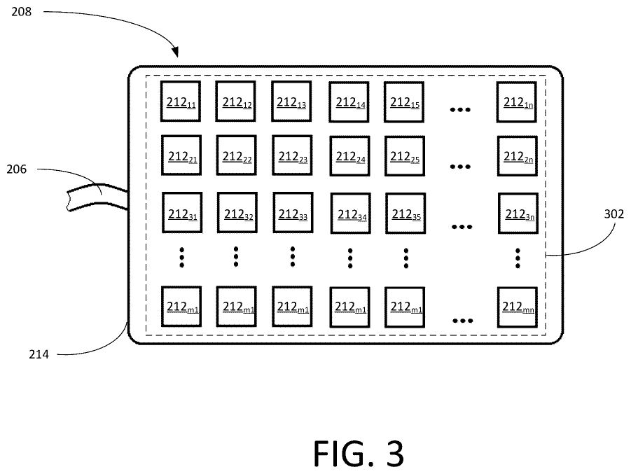

Referring now to FIG. 3 in addition to FIG. 2, in one embodiment, the light source 208 comprises one or more of LEDs 212₁₁, . . . , 212ₘₙ arranged on the PCB 214 in an array 302. In the illustrated embodiment, m is a non-zero positive integer that represents the number of rows of the array 302 and n is a non-zero positive integer that represents the number of columns of the array 302, such that a total number of m×n of LEDs is provided. The configuration of the LED array 302 (i.e. the number and type of LEDs 212₁₁, . . . , 212ₘₙ as well as the spacing or pitch therebetween) may vary depending on the design of the lighting system 100 (e.g., light intensity and/or size requirements) and/or on the size and location (e.g., indoor vs. outdoor) of the panel 102 that is to be illuminated. In one embodiment, m is set to one (1) in order to provide a one-dimensional array 302. It should however be understood that, depending on the size of the panel 102, m may be set to a value greater than one (1) such that the array 302 may be two-dimensional. The LEDs 212₁₁, . . . , 212ₘₙ may be of a same type or of different types. The LEDs 212₁₁, . . . , 212ₘₙ may comprise white light LEDs or coloured LEDs. For instance, addressable RGB (red, green, blue) LEDs may apply. In some embodiments, different LED technologies may be used within the same array 302.

Due to etendue limitations, the size relationship between the geometry of the LEDs 212₁₁, . . . , 212ₘₙ arranged on the PCB 214 and the thickness of panel 102 may impact the performance of the lighting system 100. More specifically, in embodiments where the panel 102 has a thickness of approximately 3 mm, selecting a PCB 214 with a transverse width of less than 2 mm may increase the degree of coupling between the lighting system 100 and panel 102 and therefore reduce glare in the lighting system 100. Most existing LED PCB lighting systems are based on SMD 2835 LEDs (or similar) which have a standard form factor of 2.8×3.5 mm. This form factor, combined with a typically wide beam output (+/−90 degrees) creates an untenable geometric concentration ratio into a 3 mm panel 102. In one embodiment, it may be possible to increase the degree of coupling between the lighting system 100 and the panel 102, and reduce glare of the lighting system 100 by using LEDs 212₁₁, . . . , 212ₘₙ that have a smaller size and narrower beam outputs (e.g. 30 degrees, 45 degrees, and 60 degrees) than SMD 2835 LEDs (e.g. using SMD 2016 LEDs).

Referring now to FIGS. 4A, 4B, 4C, 4D, and 4E, different embodiments of the coupling medium 210 will now be described. In the embodiment of FIG. 4A, a lens 216a having an isosceles right angle triangular cross-section is illustrated. In the embodiment of FIG. 4B, a lens 216b having a half-round cross-section is illustrated. In the embodiment of FIG. 4C, a lens 216c having an equilateral triangular cross-section is illustrated. In the embodiment of FIG. 4D, a lens 216d having a right-angled triangular cross-section is illustrated, the lens 216d comprising a substantially flat surface 217d (opposite to the lens surface, not shown, in contact with the panel 102). In the embodiment of FIG. 4E, a parabolic lens 216e comprising a parabolic surface 217e (opposite to the lens surface in contact with the panel 102 and whose shape is part of a circular paraboloid) is illustrated. It should however be understood that, depending on the application, other cross-sectional shapes may apply. Parameters of the lens (reference 216 in FIG. 2), including, but not limited to, the shape and size of the lens 216 as well as the refraction index matching between the lens 216 and the panel 102, may be determined based on the application (e.g., on the desired light coupling to be achieved).

With reference to FIGS. 4D and 4E, in some embodiments, the cover member 202 may comprise an attachment member 202x for coupling the cover member 202 to a surface of the panel 102, for instance to surface 104. Any suitable attachment member 202x may apply. In some embodiments, the attachment member 202x may comprise a mechanical fastener, such as screw(s) or the like. In other embodiments, the attachment member 202x may comprise an adhesive layer, adhesive tape, or the like. In some embodiments, the coupling medium 210 may comprise an optical bond 210s coupling the lens 216d or 216e to a surface (e.g. surface 104) of the panel 102. In one embodiment, the optical bond 210s has an index of refraction between about 1.3 and about 1.43. A silicone-based optical bond may be used for the optical bond 210s. It should however be understood that an optical bonds 210s comprising a different material, for instance epoxy or polyurethane, may also apply.

In some embodiments, the light source 208 may be positioned relative to the coupling medium 210 such that an air gap (not shown) is provided between the light source 208 and the coupling medium 210. Provision of the air gap and optical bond 210s may improve the coupling efficiency of the lighting system 100 to the panel 102 and offset some of the coupling losses that may result from the use of the lens 216d of FIG. 4D having the flat surface 217d.

In some embodiments, the parabolic surface 217e of parabolic lens 216e of FIG. 4E may be coated using a mirror coating 211, which may improve the coupling efficiency of the lighting system 100 to panel 102. The mirror coating 211 may be applied during manufacturing or assembly of the lighting system 100, coupling medium 210, and/or sub-components thereof. Although illustrated in FIG. 4E as comprising a single layer of material, the mirror coating 211 may comprise one or more layers of metallic materials such as aluminum and/or silver, although other materials may also be considered.

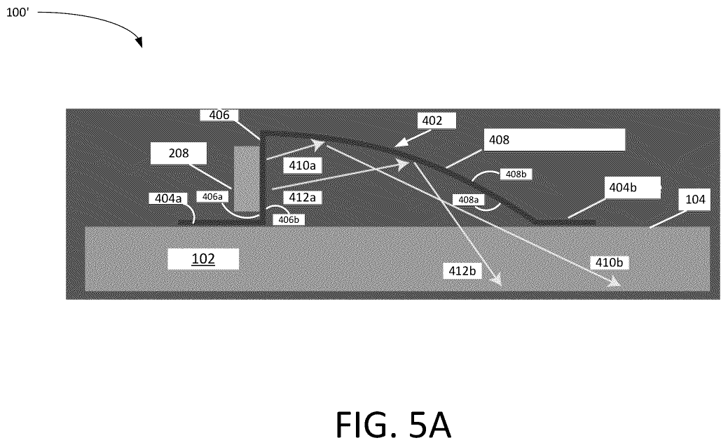

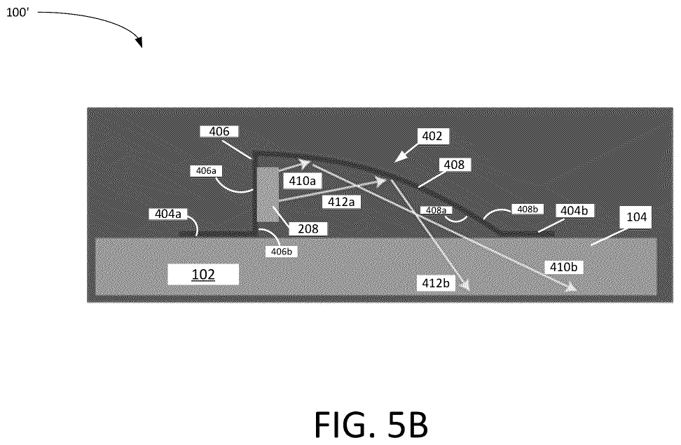

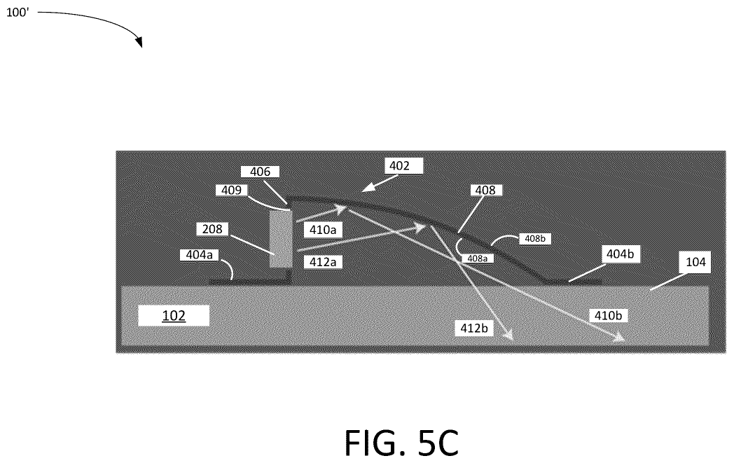

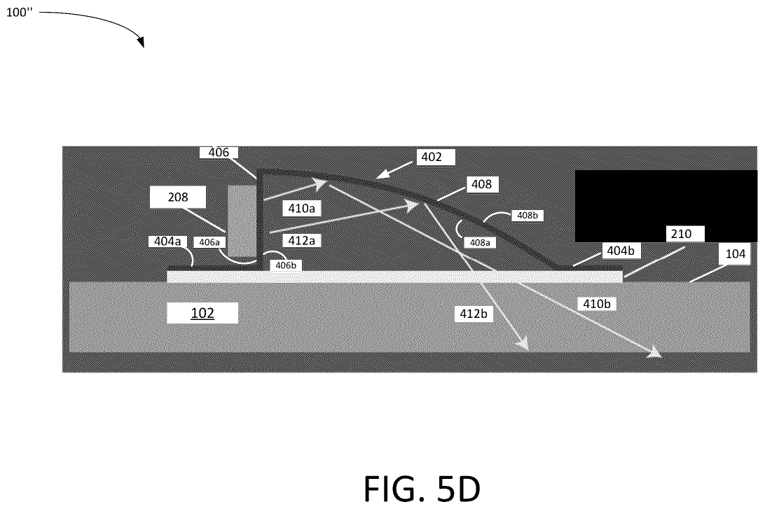

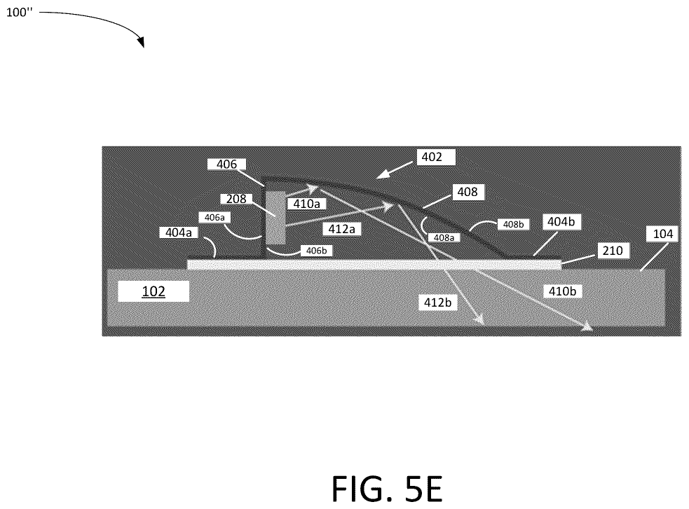

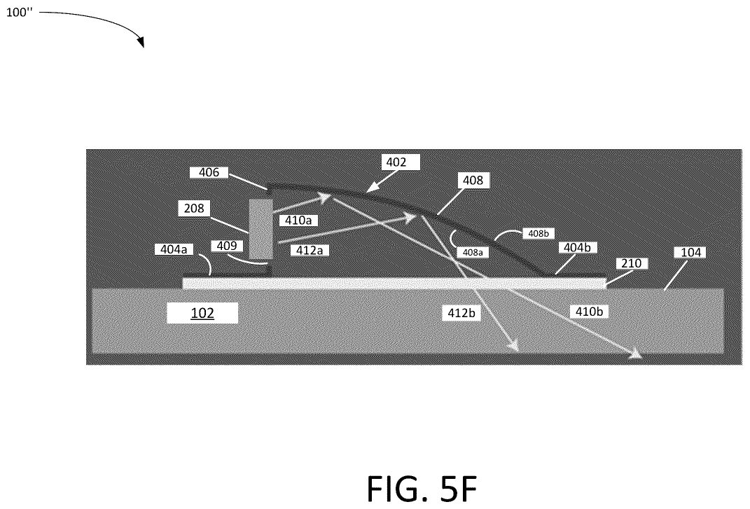

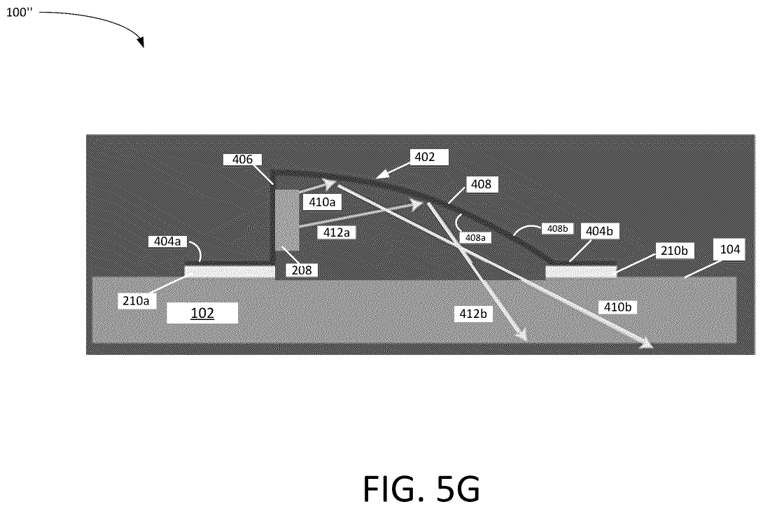

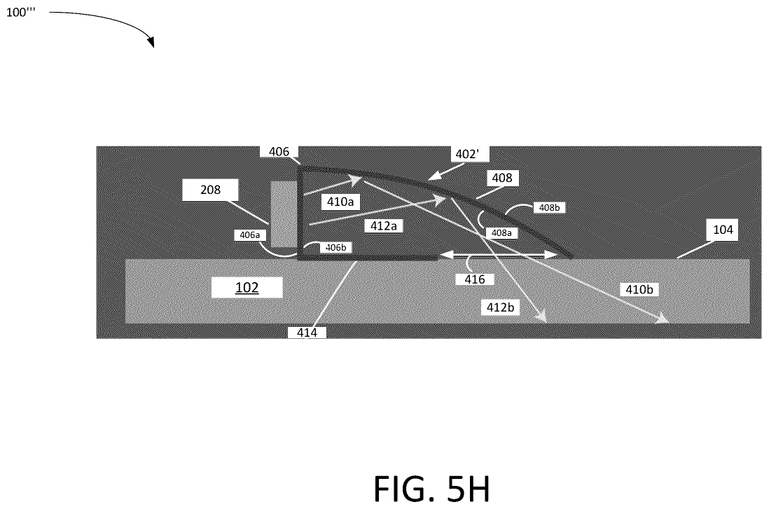

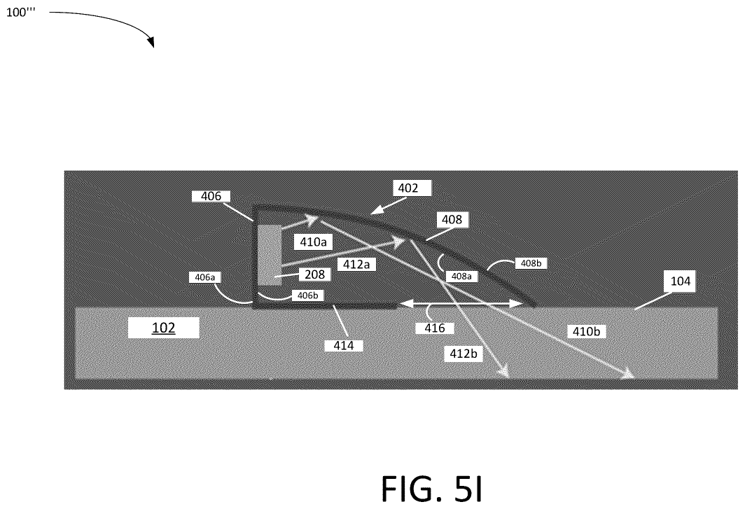

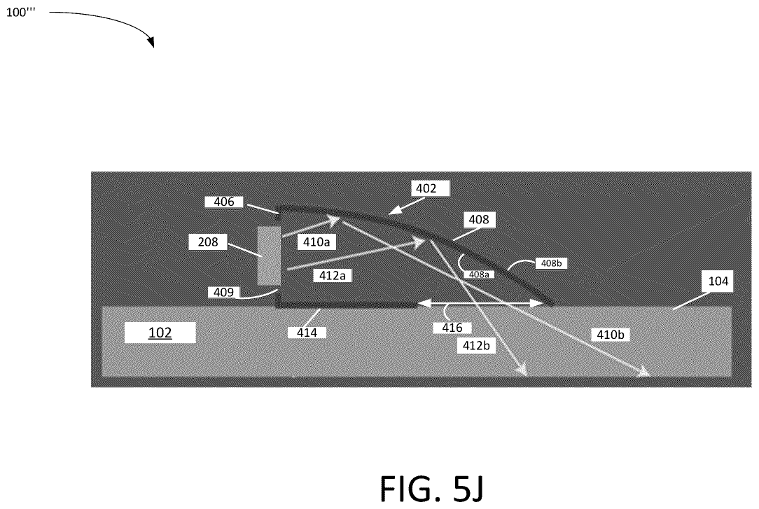

FIG. 5A illustrates a lighting system 100′ in accordance with another embodiment. The lighting system 100′ is used to illuminate panel 102 using light source 208. The lighting system 100′ comprises a reflective optical device (also referred to herein as a “reflective optic”) 402 that is coupled to the panel 102. In the embodiment of FIG. 5A, rather than using a lens as in 216, the reflective optic 402 is used to cause light incident from the light source 208 to enter the panel 102. In particular, the reflective optic 402 is used to internally reflect the incident light (i.e. bend lights rays at desired angles) and direct the reflected light into the panel 102. In the illustrated embodiment, the reflective optic 402 is a substantially hollow member comprising smooth interconnected surfaces, namely a first (or flange) surface 404a, a second (or side) surface 406, a third (or upper) surface 408, and a fourth (or flange) surface 404b. The third surface 408 is substantially curved (e.g., convex) while surfaces 404a, 406, and 404b are substantially planar. The flange surfaces 404a, 404b are substantially horizontal and extend away from the surfaces 406 and 408, respectively, substantially parallel to the upper surface 104 of the panel 102. The flange surfaces 404a, 404b are configured to be coupled to the upper surface 104 of the panel 102 (using any suitable means), in order to secure the reflective optic 402 to the panel 102. The second surface 406 is positioned so as to be substantially perpendicular to the first flange surface 404a (i.e. surfaces 404a and 406 are at an angle of substantially ninety (90) degrees) and is configured to have the light source 208 secured thereto (using any suitable means and in any suitable position or configuration).

In one embodiment (illustrated in FIG. 5A), the light source 208 is positioned outside of the reflector assembly, i.e. the light source 208 is secured to an outer face 406a of the second surface 406. In other embodiments, the light source 208 may be positioned inside the reflector assembly. For instance, FIG. 5B illustrates an example in which the light source 208 is secured to an inner face 406b (which is opposite to the outer face 406a) of the second surface 406. FIG. 5C illustrates another example in which the light source 208 is received in an opening 409 formed in the second surface 406. It should also be understood that the reflective optic 402 may have any suitable shape.

The third surface 408 has an inner face 408a and an outer face 408b opposite the inner face 408a. The inner face 408a of the reflective optic 402 is reflective and may be made of any suitable material including. In one embodiment, the inner face 408a is made of a material including, but not limited to, acrylic (e.g., having a refractive index of 1.489), styrene (e.g., having a refractive index of 1.51), styrene acrylonitrile copolymer (SAN) (e.g., having a refractive index of 1.56), and transparent styrene acrylic copolymers such as NAS® (e.g., having a refractive index of 1.77). It should however be understood that, in other embodiments, the inner face 408a may not be made of a material with a particular refractive index. This may, for instance, be the case where light is introduced by having the light source 208 inside of the reflective optic 402 or through an opening in the reflective optic 402 (e.g., as illustrated in FIGS. 5B and 5C and described herein above).

In some embodiments, the outer face 408b may also be reflective, although it should be understood that the outer face 408b need not be reflective in all embodiments. The outer face 408b is exposed to the outside environment (i.e. the environment surrounding the light system 100′). The inner face 408a reflects the light that is incident to the panel 102. In some embodiments, a reflective coating may be applied on the inner surface 408a of the reflective optic 402. Other embodiments may apply. Light is reflected within the reflective optic 402 at an angle determined by the angle at which the light is incident on the panel 102. More specifically, in the illustrated embodiment, incident light is emitted by the light source 208 into the reflective optic 402, along one or more directions illustrated as arrows 410a and 412a. Although FIG. 5A illustrates (for clarity purposes) the incident light as being emitted by the light source 208 along two directions (illustrated by arrows 410a, 412a), it should be understood that the light may be emitted in any suitable manner. In particular, light typically spreads out from the source 208 in all directions such that light may be emitted from the light source 208 in any suitable direction and any suitable number of light rays may be emitted.

The light emitted along the direction illustrated by arrow 410a is incident on the inner face 408a where it is reflected and directed into the panel 102 along a direction illustrated by arrow 410b, which is angled relative to the direction illustrated by arrow 410a. Similarly, the light emitted along the direction illustrated by arrow 412a is incident on the inner face 408a where it is reflected and directed into the panel 102 along a direction illustrated by arrow 412b, which is angled relative to the direction illustrated by arrow 412a. The angle between a given direction of incidence (e.g., the direction illustrated by arrow 410a or 412a) and the corresponding direction of reflection (e.g., the direction illustrated by arrows 410b or 412b) may vary depending on the shape and size of the reflective optic 402. In one embodiment, the light is reflected at the inner face 408a via specular reflection, such that all of the components of the incident light are reflected substantially equally and the reflected specular light follows a trajectory that has the same angle (not shown) from the normal to the inner face 408a as the incident light. Although not shown in FIG. 5A, it should be understood that the light that enters the panel 402 (e.g., along the directions illustrated by arrows 410b, 412b) propagates within the panel 102 by TIR, in the manner described herein above with reference to FIG. 2.

FIG. 5D illustrates a lighting system 100″ in accordance with another embodiment. The reflective optic 402 of FIG. 5D has the same configuration as in FIG. 5A. However, in the embodiment of FIG. 5D, the coupling medium 210 (e.g., comprising an optical bond as described herein above) is used to couple the reflective optic 402 to the panel 102. In particular, the reflective optic 402 is interposed between the light source 208 and the coupling medium 210, with the flanges 404a, 404b being coupled to upper surface 104 of the panel 102 using the coupling medium 210. In one embodiment (illustrated in FIG. 5D), the light source 208 is positioned outside of the reflector assembly, i.e. the light source 208 is secured to the outer face 406a of the second surface 406. In other embodiments, the light source 208 may be positioned inside the reflector assembly. For instance, similarly to the embodiment illustrated in FIG. 5B described above, FIG. 5E illustrates an example in which the light source 208 is secured to the inner face 406b (which is opposite to the outer face 406a) of the second surface 406. FIG. 5F illustrates another example in which the light source 208 is received in the opening 409 formed in the second surface 406 (similarly to the embodiment illustrated in FIG. 5C described above).

The coupling medium 210 may comprise a single (i.e. unitary) coupling member, as illustrated in FIGS. 5D, 5E, and 5F, or several coupling members as in 210a, 210b, as illustrated in FIG. 5G. In the embodiment of FIG. 5G, the first coupling member 210a is interposed between the first flange 404a and the panel 102 while the second coupling member 210b is interposed between the second flange 404b and the panel 102. The coupling members 210a, 210b may have any suitable size. In some embodiments, it may be desirable to the coupling members 210a, 210b to have dimensions (e.g., length, width) that match that of the flanges 404a, 404b in order enhance the coupling of the reflective optic 402 to the panel 102.

FIG. 5H illustrates a lighting system 100″ in accordance with yet another embodiment. The reflective optic 402′ of FIG. 5H does not include flanges 404a, 404b (as described above with reference to FIG. 5A) but instead comprises a bottom surface 414, which has one end (not shown) connected to the side surface 406. The bottom surface 414 is configured to be positioned against the upper surface 104 of the panel 210 and secured thereto (using any suitable means) in order to hold the reflective optic 102 in place relative to the panel 102. As can be seen from FIG. 5H, the other end (not shown) of the bottom surface 414 is not connected to the curved surface 408, such that the contour of the reflective optic 402′ is not closed. In other words, an opening 416 is created in the bottom part (i.e. the bottom surface 414) of the reflective optic 402′, with the reflected light being directed through the opening 416 and into the panel 102 (along the direction illustrated by arrows 410b, 412b). The opening 416 may have any suitable dimension, depending on the application.

Similarly to the embodiments described above with reference to FIGS. 5A and 5D, in one embodiment (illustrated in FIG. 5H), the lighting system 100″ has the light source 208 positioned outside of the reflector assembly, i.e. the light source 208 is secured to the outer face 406a of the second surface 406. In other embodiments, the lighting system 100″ may have the light source 208 positioned inside the reflector assembly. For instance, similarly to the embodiments illustrated in FIGS. 5B and 5E described above, FIG. 5I illustrates an example in which the light source 208 is secured to the inner face 406b. FIG. 5J illustrates another example in which the lighting system 100″ has the light source 208 received in the opening 409 formed in the second surface 406 (similarly to the embodiment illustrated in FIGS. 5C and 5F described above).

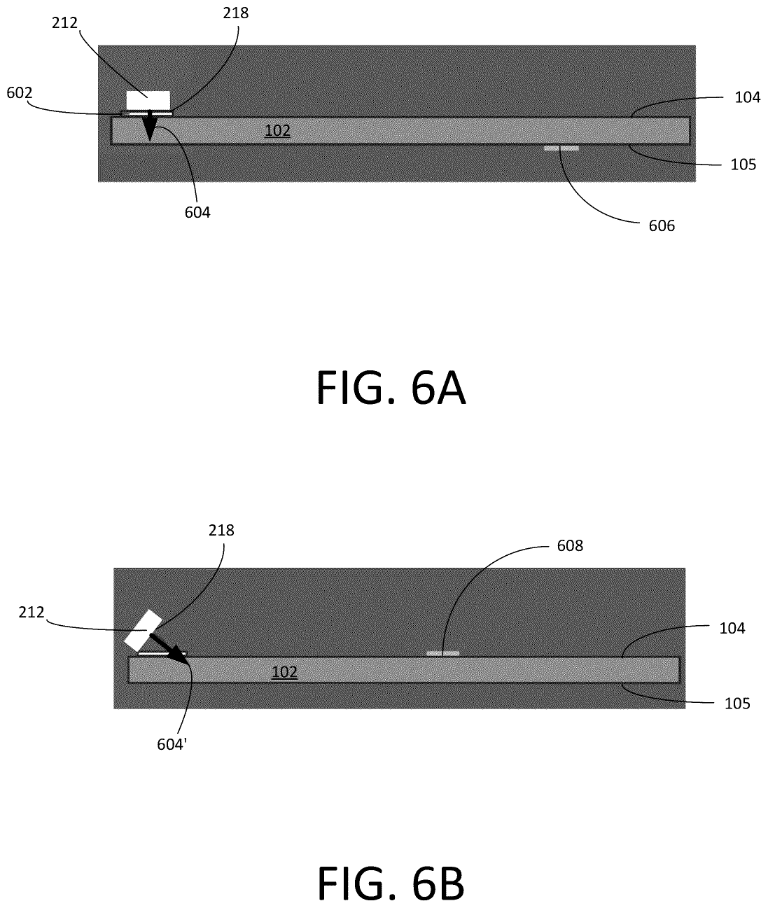

Referring now to FIG. 6A and FIG. 6B, while it may, in some embodiments, be desirable to use the lens 216 in order to improve light intensity, the coupling medium 210 may, in some embodiments, only comprise a semi-translucent material 602 (e.g., an adhesive, gel, silicon, or the like) and no lens 216 may be provided. In other words, a binding material such as the material 602, may form the coupling medium 210 (i.e., form an optical device). This is illustrated in FIG. 6A, where the light-emitting surface 218 of the LEDs 212 is positioned against a surface (e.g., surface 104) of the panel 102, with the semi-translucent material 602 interposed between the surfaces 104, 218. The light emitted by the LEDs 212 is incident on the surface 104 along a direction indicated by arrow 604, which is a direction substantially transverse to the surface 104. It should however be understood that the angle (reference α in FIG. 2) between the surfaces 104, 218 may vary and that, in some embodiments, the surface 218 may be positioned at a non-zero angle relative to the surface 104, as illustrated in FIG. 6B. As a result, the direction (indicated by arrow 604′) of the incident light may be at an angle to the surface 104. The value of the angle between the surfaces 104, 218 is selected such that the incident light is directed through the panel 102 in such a manner as to maximize illumination of the indicium 606, 608 provided on the surface(s) 104, 105 of the panel 102.

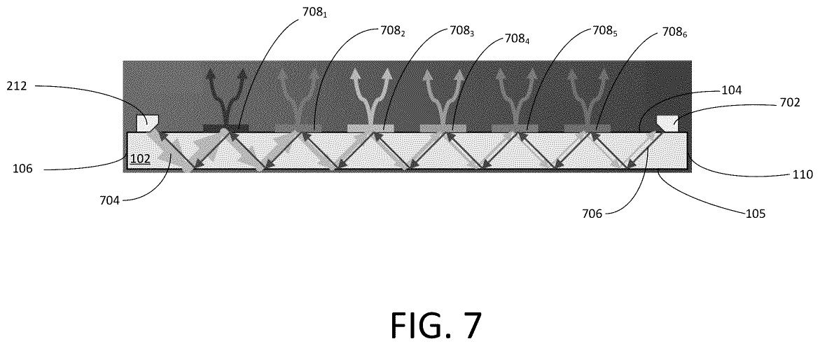

Referring now to FIG. 7 in addition to FIG. 1, it will be noted that the exposed edge(s) (e.g., edges 108, 110, and/or 112) of the panel 102 may bleed any unabsorbed light emitted by the lighting system 100. In addition, as light propagates through the panel 102, the light decreases in intensity such that indicia that are further away from the light source (reference 208 in FIG. 2) receive less illumination (i.e. are dimmer) than indicia that are closer to the light source 208. In some embodiments, in order to minimize edge bleeding and increase the coupling efficiency (i.e. the overall illumination potential) of the lighting system 100, a reflector 702 may be provided at the edge (e.g., edge 110) opposite to the edge (e.g., edge 106) where the light source 208 (e.g., the LEDs 212) is provided. As shown in FIG. 7, the reflector 702 is configured to reflect the light 704 emitted by the LEDs 212 back towards the edge 106. In particular, the reflector 702 reflects the light 704 by 180°, allowing unabsorbed light 706 to propagate backwards through the panel 102. In this manner, the indicia as in 708₁, . . . , 708₆ may receive a similar amount of illumination and the overall coupling efficiency of the lighting system 100 may be increased.

FIGS. 8A and 8B illustrate further embodiments of the systems described herein. According to one embodiment as illustrated in FIG. 8A, a first lighting system (or light channel) 100a is positioned adjacent edge 106 of the panel 102 and is connected to a second lighting system (or light channel) 100b positioned adjacent to the edge 108 of the panel 102. The first lighting system 100a is illustratively powered at a first end 204a thereof via a first power cord 206a and comprises internal components that are enclosed within a first cover member 202a. The first lighting system 100a causes illumination to be provided to the panel 102 along a direction 113a, from the edge 106 towards the opposite edge 110. The first lighting system 100a is coupled to the second lighting system 100b (the internal components of which are enclosed within a second cover member 202b) via a second power cord (also referred to as an extension cord or cable connection) 206b which connects the second end 205a (opposite the first end 204a) of the first lighting system 100b to an exposed end 204b of the second lighting system 100b. The second power cord 206b therefore enables power to be transferred from the first lighting system 100a to the second lighting system 100b, such that illumination is provided to the panel 102 by the second lighting system 100b, along a direction 113b, from the edge 108 towards the opposite edge 112. In other words, lighting systems 100a, 100b cooperate to provide illumination to the panel 102.

In another embodiment as illustrated in FIG. 8B, the first lighting system 100a is positioned adjacent edge 106a of a panel 102a and is connected to a second lighting system 100b positioned adjacent edge 106b of a panel 102b. The panels 102a and 102b may be substantially of similar size and composition, comprising, for example, discrete window panes within a paned window, wherein the discrete window panes may be separated from each other by a divider 802, for instance a strip or bar. Alternatively, the panels 102a and 102b may comprise separate windows altogether, located closer or farther apart depending on the architectural features of a residential, commercial, or industrial space, for instance a household having multiple windows close together. In such cases, the panels 102a and 102b may be framed, and the divider 802 may comprise the window frame of panel 102a, 102b and the space in-between. In one embodiment, the edges 106a and 106b of panels 102a and 102b and the lighting systems 100a and 100b may be substantially aligned along the axis 804. In other embodiments, the edges 106a and 106b of the panels 102a and 102b and the lighting systems 100a and 100b may be staggered in a direction orthogonal to axis 804 (not shown), among other possibilities.

The first lighting system 100a is illustratively powered at a first end 204a thereof via a first power cord 206a and comprises internal components that are enclosed within a first cover member 202a. The first lighting system 100a causes illumination to be provided to the panel 102a along a direction 113a orthogonal to the axis 804, from the edge 106a towards the opposite edge 110a. The first lighting system 100a is coupled to the second lighting system 100b (the internal components of which are enclosed within a second cover member 202b) via a second power cord (also referred to as an extension cord or cable connection) 206b which connects the second end 205a (opposite the first end 204a) of the first lighting system 100b to an exposed end 204b of the second lighting system 100b. The first power cord 206a and second power cord 206b may be provided with sufficient slack to be pulled over or across the divider 802. The second power cord 206b therefore enables power to be transferred from the first lighting system 100a to the second lighting system 100b, such that illumination is provided to the panel 102b by the second lighting system 100b, along a direction 113b orthogonal to the axis 804, from the edge 106b towards the opposite edge 110b. In other words, lighting systems 100a, 100b cooperate to provide illumination to the panels 102a and 102b.

It should be understood that, although the lighting systems 100a, 100b are illustrated as being provided at the edges 106 and 108, they may each be positioned at any one of the edges 106, 108, 110, and 112. In addition, it should be understood that more than one lighting system as in 110a, 110b may be provided at any given edge 106, 108, 110, and 112, and interconnected using a power cord as in 206b. For example, in panels 102 having a longer edge 106, the lighting systems 100a and 100b may be provided along the same edge 106. It should also be understood that any suitable number (e.g., two, four, etc.) of lighting systems may be provided and interconnected to illuminate the panel 102. Various shapes and sizes of panels as in 102 may therefore be accommodated.

In order to facilitate installation of the lighting system 100, users may be provided with the lighting system 100 as a kit. The kit may comprise a light channel configured to be secured to an exposed surface of the panel adjacent to a first edge of the panel, the light channel comprising a light source configured to emit light towards the surface of the panel and a coupling medium configured to direct the light emitted by the light source into the panel and towards a second edge of the panel opposite to the first edge. The light source and the coupling medium may be concealed by a cover member provided as part of the kit. A reflector may also be secured to the surface of the panel adjacent to the second edge for reflecting towards the first edge an unabsorbed portion of the light directed into the panel. In some embodiments, a power cord (pre-assembled or not) may be provided in the kit for connecting the light channel to an external power source (e.g., the electrical grid) for supplying power to the light source. In other embodiments wherein only an internal power source is provided with the lighting system 100, the power cord for connecting the light channel to an external power source for supplying power to the light source may be omitted from the kit. An at least partially optically clear adhesive may also be provided (e.g., pre-attached to the light channel) for detachably securing the light channel to the surface of the panel. The adhesive may be pre-assembled to the light channel for removal by the user when it is desired to secure the light channel to the window panel.

The kit may also comprise at least one means for providing on the surface of the panel at least one indicium configured to be illuminated by the light directed into the panel. Such means may comprise at least one marker for drawing the at least one indicium on the surface of the panel and/or at least one luminescent sticker configured to be affixed to the surface of the panel. The kit may also comprise at least one erasing means (e.g., a cleaner, a wiper, a sticker remover, or the like) for removing the at least one indicium from the surface of the panel. In order to accommodate panels of different shapes and sizes, the kit may also comprise additional light channels and at least one cable connection for interconnecting the multiple light channels. The light source provided in the kit may comprise a strip of LEDs having a predetermined length and custom lengths may be achieved by cutting the strip between the LEDs.

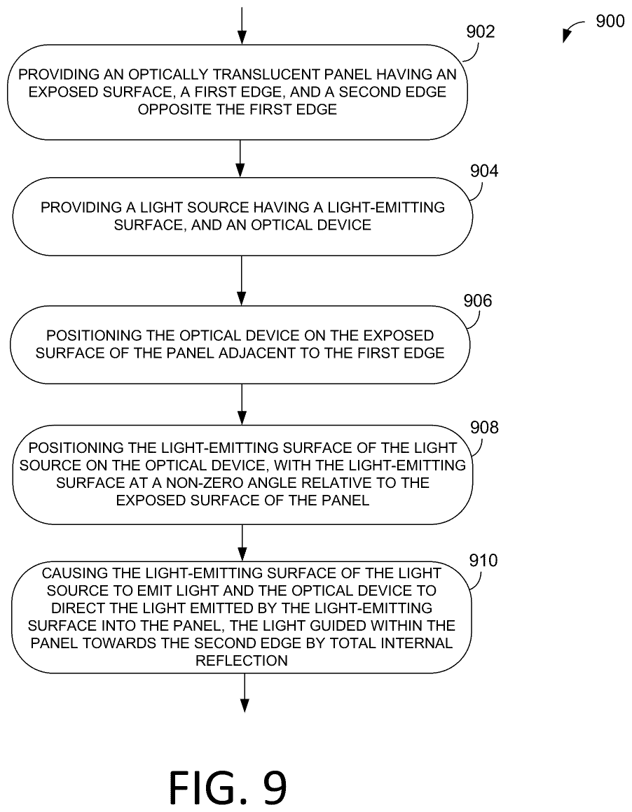

Referring now to FIG. 9, a method 900 for illuminating an optically translucent panel, such as a window panel having at least one indicium provided thereon, will now be described. At step 902, the panel having an exposed surface, a first edge, and a second edge opposite the first edge is provided. At step 904, a light source having a light-emitting surface, and an optical device (e.g., a coupling medium as described herein above) are provided. The panel, light source, and optical device may be as described herein above with reference to FIGS. 1 to 8B. Step 906 comprises positioning the optical device on the exposed surface of the panel adjacent to the first edge. Step 908 comprises positioning the light-emitting surface of the light source on the optical device, with the light-emitting surface at a non-zero angle relative to the exposed surface of the panel. The positioning (e.g., as performed at step 904) may be achieved using a suitable adhesive, as described herein above, to secure the light source and the optical device. At step 910, the light-emitting surface of the light source is caused to emit light and the optical device is caused to direct the light emitted by the light-emitting surface into the panel, the light guided within the panel towards the second edge by total internal reflection. Step 910 may be achieved by supplying power to the lighting system. By causing the light to be guided within the panel, the at least one indicium can be illuminated.

In one embodiment, using the systems and methods described herein may alleviate the need for accessing edge(s) of the window panel (e.g., removing the window frame) as edge lighting may be provided by mounting the lighting system described herein directly on the panel surface (i.e. on top of the window panel). Both sides of the window panel need not be accessed. In addition, the indicia provided on the window may be illuminated using an existing window panel and no additional substrate, mounting film, or the like may be required. As a result, installation may be facilitated and potential decorative use enhanced. Furthermore, the systems and methods described herein may alleviate the need for power cables (or other objects) being placed in the middle of the window panel, thus preventing visual obstruction. The systems and methods described herein may also prove scalable to different sizes of window panels, thus allowing for different configurations of the lighting systems. For example, multiple lighting systems may be chained together to form a longer modular unit having a customized length.

As can be seen therefore, the examples described above and illustrated are intended to be exemplary only. The scope is indicated by the appended claims.

What is claimed is:

1. A lighting system for illuminating an optically translucent panel, the panel having an exposed surface, a first edge, and a second edge opposite the first edge, the lighting system comprising:
a light source having a light-emitting surface; and
an optical device configured to be positioned on the exposed surface of the panel adjacent to the first edge, the light-emitting surface of the light source configured to be positioned on the optical device at a non-zero angle relative to the exposed surface of the panel, the optical device configured to direct light emitted by the light-emitting surface into the panel, the light guided within the panel towards the second edge by total internal reflection.

2. The lighting system of claim 1, wherein the light source comprises one or more light-emitting diodes (LEDs) arranged in an array on a printed circuit board.

3. The lighting system of claim 1, wherein the light source comprises a single light element.

4. The lighting system of claim 1, wherein the optical device is configured to be detachably secured to the exposed surface of the panel using a binding material that is at least partially optically clear, the binding material configured to optically couple the optical device to the panel.

5. The lighting system of claim 4, wherein the binding material is an adhesive.

6. The lighting system of claim 4, wherein the binding material is made of silicon.

7. The lighting system of claim 4, wherein the binding material is a gel.

8. The lighting system of claim 4, wherein the binding material forms the optical device.

9. The lighting system of claim 1, wherein the optical device is a lens configured to refract the light emitted by the light-emitting surface into the panel.

10. The lighting system of claim 9, wherein the lens has a triangular cross-section.

11. The lighting system of claim 9, wherein the lens is a parabolic lens comprising a parabolic surface.

12. The lighting system of claim 11, wherein the parabolic surface of the parabolic lens is coated with a mirror coating.

13. The lighting system of claim 1, wherein the optical device comprises a convex reflective surface, further wherein the light emitted by the light-emitting surface is incident on the reflective surface, the reflective surface configured to internally reflect the incident light towards the panel.

14. The lighting system of claim 13, wherein the optical device has a planar side surface and a curved upper surface, each having an inner face and an outer face opposite the inner face, the inner face of the upper surface forming the reflective surface.

15. The lighting system of claim 14, wherein the light source is secured to the outer face of the side surface.

16. The lighting system of claim 14, wherein the light source is secured to the inner face of the side surface.

17. The lighting system of claim 14, wherein the light source is received in an opening formed in the side surface.

18. The lighting system of claim 14, wherein the optical device further comprises a first flange surface and a second flange surface, the first flange surface connected to the side surface and extending away therefrom, the second flange surface connected to the upper surface and extending away therefrom.

19. The lighting system of claim 18, wherein the first flange surface and the second flange surface are configured to be coupled to the exposed surface of the panel using a coupling medium.

20. The lighting system of claim 14, wherein the optical device further comprises a planar bottom surface having one end connected to the side surface, the bottom surface configured to be coupled to the exposed surface of the panel.

21. The lighting system of claim 20, wherein the bottom surface has an opening formed therein, the light emitted by the light-emitting surface directed into the panel via the opening.

22. The lighting system of claim 1, further comprising a power source integral to the lighting system, the power source electrically connected to the light source for supplying power thereto.

23. The lighting system of claim 1, wherein the optical device is configured to direct the light emitted by the light source into the panel for illuminating at least one indicium provided on the exposed surface of the panel.

24. A method for illuminating an optically translucent panel, the method comprising:
providing the panel having an exposed surface, a first edge, and a second edge opposite the first edge;
providing a light source having a light-emitting surface, and an optical device;
positioning the optical device on the exposed surface of the panel adjacent to the first edge;
positioning the light-emitting surface of the light source on the optical device, with the light-emitting surface at a non-zero angle relative to the exposed surface of the panel; and
causing the light-emitting surface of the light source to emit light and the optical device to direct the light emitted by the light-emitting surface into the panel, the light guided within the panel towards the second edge by total internal reflection.

25. A kit for use in illuminating an optically translucent panel, the panel having an exposed surface, a first edge, and a second edge opposite the first edge, the kit comprising:
at least one light channel configured to be secured to the exposed surface of the panel adjacent to the first edge of the panel, the at least one light channel comprising a light source having a light-emitting surface and an optical device, the light-emitting surface configured to be positioned on the optical device at a non-zero angle relative to the exposed surface of the panel and the optical device configured to direct light emitted by the light-emitting surface into the panel, the light guided within the panel towards the second edge by total internal reflection; and
at least one means for providing on the exposed surface of the panel at least one indicium configured to be illuminated by the light guided within the panel.

26. The kit of claim 25, wherein the at least one means for providing the at least one indicium comprises at least one marker for drawing the at least one indicium on the exposed surface of the panel.

27. The kit of claim 25, wherein the at least one means for providing the at least one indicium comprises at least one luminescent sticker configured to be affixed to the exposed surface of the panel.

28. The kit of claim 25, further comprising at least one erasing means for removing the at least one indicium from the exposed surface of the panel.

29. The kit of claim 25, further comprising at least one cable connection for interconnecting multiple ones of the at least one light channel.

30. The kit of claim 25, further comprising a power cord for connecting the at least one light channel to an external power source for supplying power to the light source.

31. The kit of claim 25, further comprising a power source configured to be electrically connected to the light source for supplying power thereto.

32. The kit of claim 25, further comprising a binding material for detachably securing the at least one light channel to the surface of the panel, the binding material being at least partially optically clear and configured to optically couple the at least one light channel to the panel.

33. The kit of claim 32, wherein the binding material forms the optical device.

34. The kit of claim 32, wherein the binding material is an adhesive, a gel, or is made of silicon.

35. The kit of claim 25, further comprising a cover member for concealing the light source and the optical device.
